(19) United States
(12) Patent Application Publication
(10) Pub. No.: US 2007/0254183 A1
(43) Pub. Date: Nov. 1, 2007

(54) Electroluminescent materials and deivces

(76) Inventor: Poopathy Kathirgamanathan, North Harrow (GB)

Correspondence Address: David Silverstein;Andover -Ip -Law, 44 Park Street , Suite 300, Andover, MA, 01810, US

(21) Appl. No.: 11/660,626

(22) PCT Filed: Aug. 26, 2005
(86) PCT No.: PCT/GB05/03327

§ 371 Date: Mar. 27, 2007

(30) Foreign Application Priority Data
Aug. 31, 2004 (GB) 0419267.0

(51) Int. Cl. B32B 19/00

(52) U.S. Cl. 428/690

(57) ABSTRACT

An improved method for making a zirconium 2-methyl 8 hydroxy quinolate is a two-stage process of reacting a zirconium salt with 2-methyl 8 hydroxy quinoline and then reacting the mixed salt formed with a beta diketone.

The present invention relates to a method for the manufacture of electroluminescent materials and to electroluminescent devices incorporating such materials.

Materials which emit light when an electric current is passed through them are well known and used in a wide range of display applications. Liquid crystal devices and devices which are based on inorganic semiconductor systems are widely used; however these suffer from the disadvantages of high energy consumption, high cost of manufacture, low quantum efficiency, making them ineffective, for example, in producing flat panel displays.

Organic polymers have been proposed as useful in electroluminescent devices, but it is not possible to obtain pure colours; they are expensive to make and have a relatively low efficiency.

Patent application WO98/58037 describes a range of lanthanide complexes which can be used in electroluminescent devices which have improved properties and give better results. Patent applications PCT/GB98/01773, PCT/GB99/03619, PCT/GB99/04030, PCT/GB99/04024, PCT/GB99/04028, PCT/GB00/00268 describe electroluminescent complexes, structures and devices using rare earth chelates.

Another compound which has been proposed as an electroluminescent material for use in electroluminescent devices is aluminium quinolate.

U.S. Pat. No. 3,995,299 (Partridge) discloses an electroluminescent device comprising in sequence, an anode, an organic hole injecting and transporting zone, a luminescent zone, an electron transporting zone and a cathode. The luminescent zone can be an organic polymer such as a polyvinyl carbazole doped with a fluorescent dye such as a perylene or an acridine, etc.

U.S. Pat. No. 4,769,292 (Kodak) discloses an electroluminescent device comprising in sequence, an anode, an organic hole injecting and transporting zone, a luminescent zone, and a cathode. The EL device is characterized in that the luminescent zone is formed by a thin film of less than 1 μm in thickness comprised of an organic host material and a fluorescent material capable of emitting light. The luminescent zone exemplified in the specification contains aluminium quinolate, and other metal quinolates with a valency of 1 to 3 are also referred to and claimed.

Patent Application PCT/GB03/05573 discloses the use of metal quinolates including zirconium quinolates and discloses the use of zirconium 2-methyl quinolate.

However zirconium 2-methyl quinolate is difficult to synthesise in good yield and attempts to make zirconium 2-methyl quinolate by conventional methods such as the reaction of a zirconium salt with 2-methyl 8-hydroxy quinoline have not been successful due to the formation of a mixed zirconium compound according to the reaction
ZrL₄+4(q-2Me)→Zr(q-2Me)₂L₂

We have now discovered an improved method for the synthesis of zirconium 2-methyl quinolate.

According to the invention there is provided a method for the manufacture of zirconium 2-methyl quinolate which comprises reacting a zirconium salt ZrL₄ (where L is an anion) with 2-methyl 8-hydroxy quinoline to form the mixed salt Zr(q-2Me)₂L₂ and then reacting the mixed salt with a beta diketone to form zirconium 2-methyl quinolate. The zirconium 2-methyl quinolate can be unsubstituted or substituted.

The reaction takes place according to the reaction scheme
ZrL₄4(q-2Me)→Zr(q-2Me)₂L₂ (1)
2Zr(q-2Me)₂_{^{+4acac}}→Zrq-2Me)₄+Zr(acac)₄ (2)

Where 2-methyl 8-hydroxy quinoline is 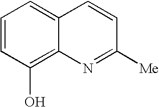
and acac is a beta diketone preferably of formula

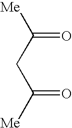

The zirconium salt is preferably an alkoxide such as zirconium butoxide and the reaction can take place in an organic solvent such as dichloromethane, tetrahydrofuran etc. After the formation of the salt by reaction (1) above the acetyl acetate can then be added to the reaction mixture to form the zirconium tetroxide complex.

The preferred 8-hydroxy 2-methyl quinolines have the formula 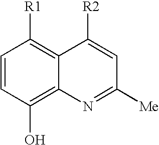
where R1 and R2, which may be the same or different, are hydrogen or alky, alkoxy, aryl, aryloxy, sulphonic acids, esters, carboxylic acids, amino and amido groups or are aromatic, polycyclic or heterocyclic groups.

The preferred zirconium quinolates formed will have the formula 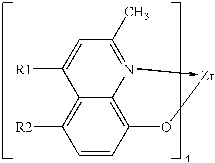
where R1 and R2 are as above.

The invention also provides an electroluminescent device which comprises (i) a first electrode (ii) a layer of an electroluminescent material comprising a substituted or unsubstituted 2-methyl zirconium quinolate made by the method disclosed above and (iii) a second electrode.

The 2-methyl zirconium quinolate can be doped with a dopant.

Preferably the electroluminescent compound is doped with a minor amount of a fluorescent material as a dopant, preferably in an amount of 5 to 15% by weight of the doped mixture.

As discussed in U.S. Pat. No. 4,769,292, the contents of which are included by reference, the presence of the fluoresecent material permits a choice from amongst a wide latitude of wavelengths of light emission.

As stated in U.S. Pat. No. 4,769,292 by blending with the organo metallic complex, a minor amount of a fluorescent material capable of emitting light in response to hole-electron recombination, the hue light emitted from the luminescent zone, can be modified. In theory, in the present application if zirconium 2-methyl quinolate and a fluorescent material could be found for blending which have exactly the same affinity for hole-electron recombination, each material should emit light upon injection of holes and electrons in the luminescent zone. The perceived hue of light emission would be the visual integration of both emissions.

Since imposing such a balance of zirconium 2-methyl quinolate and fluorescent materials is highly limiting, it is preferred to choose the fluorescent material so that it provides the favoured sites for light emission. When only a small proportion of fluorescent material providing favoured sites for light emission is present, peak intensity wavelength emissions typical of the zirconium 2-methyl quinolate can be entirely eliminated in favour of a new peak intensity wavelength emission attributable to the fluorescent material. While the minimum proportion of fluorescent material sufficient to achieve this effect varies, in no instance is it necessary to employ more than about 10 mole percent fluorescent material, based on moles of zirconium 2-methyl quinolate and seldom is it necessary to employ more than 1 mole percent of the fluorescent material. On the other hand, for zirconium 2-methyl quinolate, limiting the fluorescent material present to extremely small amounts, typically less than about 10⁻³ mole percent, based on zirconium 2-methyl quinolate, can result in retaining emission at wavelengths characteristic of the zirconium 2-methyl quinolate. Thus, by choosing the proportion of a fluorescent material capable of providing favoured sites for light emission, either a fall or partial shifting of emission wavelengths can be realized. This allows the spectral emissions of the EL devices of this invention to be selected and balanced to suit the application to be served.

Choosing fluorescent materials capable of providing favoured sites for light emission, necessarily involves relating the properties of the fluorescent material to those of the zirconium 2-methyl quinolate. The zirconium 2-methyl quinolate can be viewed as a collector for injected holes and electrons with the fluorescent material providing the molecular sites for light emission. One important relationship for choosing a fluorescent material capable of modifying the hue of light emission when present in zirconium 2-methyl quinolate is a comparison of the reduction potentials of the two materials. The fluorescent materials demonstrated to shift the wavelength of light emission have exhibited a less negative reduction potential than that of the zirconium 2-methyl quinolate. Reduction potentials, measured in electron volts, have been widely reported in the literature along with varied techniques for their measurement. Since it is a comparison of reduction potentials rather than their absolute values which is desired, it is apparent that any accepted technique for reduction potential measurement can be employed, provided both the fluorescent and zirconium 2-methyl quinolate reduction potentials are similarly measured. A preferred oxidation and reduction potential measurement techniques is reported by R. J. Cox, Photographic Sensitivity, Academic Press, 1973, Chapter 15.

A second important relationship for choosing a fluorescent material capable of modifying the hue of light emission when present in zirconium 2-methyl quinolate is a comparison of the bandgap potentials of the two materials. The fluorescent materials demonstrated to shift the wavelength of light emission have exhibited a lower bandgap potential than that of the zirconium 2-methyl quinolate. The bandgap potential of a molecule is taken as the potential difference in electron volts (eV) separating its ground state and first singlet state. Bandgap potentials and techniques for their measurement have been widely reported in the literature. The bandgap potentials herein reported are those measured in electron volts (eV) at an absorption wavelength which is bathochromic to the absorption peak and of a magnitude one tenth that of the magnitude of the absorption peak. Since it is a comparison of bandgap potentials rather than their absolute values which is desired, it is apparent that any accepted technique for bandgap measurement can be employed, provided both the fluorescent and zirconium 2-methyl quinolate bandgaps are similarly measured. One illustrative measurement technique is disclosed by F. Gutman and L. E. Lyons, Organic Semiconductors, Wiley, 1967, Chapter 5.

With zirconium 2-methyl quinolate, which is itself capable of emitting light in the absence of the fluorescent material, it has been observed that suppression of light emission at the wavelengths of emission characteristics of the zirconium 2-methyl quinolate alone and enhancement of emission at wavelengths characteristic of the fluorescent material occurs when spectral coupling of the zirconium 2-methyl quinolate and fluorescent material is achieved. By “spectral coupling” it is meant that an overlap exists between the wavelengths of emission characteristic of the zirconium 2-methyl quinolate alone and the wavelengths of light absorption of the fluorescent material in the absence of the zirconium 2-methyl quinolate. Optimal spectral coupling occurs when the emission wavelength of the zirconium 2-methyl quinolate is ±25 nm of the maximum absorption of the fluorescent material alone. In practice advantageous spectral coupling can occur with peak emission and absorption wavelengths differing by up to 100 nm or more, depending on the width of the peaks and their hypsochromic and bathochromic slopes. Where less than optimum spectral coupling between the zirconium 2-methyl quinolate and fluorescent materials is contemplated, a bathochromic as compared to a hypsochromic displacement of the fluorescent material produces more efficient results.

Useful fluorescent materials are those capable of being blended with the zirconium 2-methyl quinolate and fabricated into thin films satisfying the thickness ranges described above forming the luminescent zones of the EL devices of this invention. While crystalline organo metallic complexes do not lend themselves to thin film formation, the limited amounts of fluorescent materials present in the zirconium 2-methyl quinolate materials permits the use of fluorescent materials which are alone incapable of thin film formation. Preferred fluorescent materials are those which form a common phase with the zirconium 2-methyl quinolate material. Fluorescent dyes constitute a preferred class of fluorescent materials, since dyes lend themselves to molecular level distribution in the zirconium 2-methyl quinolate. Although any convenient technique for dispersing the fluorescent dyes in the zirconium 2-methyl quinolatees can be undertaken, preferred fluorescent dyes are those which can be vacuum vapor deposited along with the zirconium 2-methyl quinolate materials. Assuming other criteria, noted above, are satisfied, fluorescent laser dyes are recognized to be particularly useful fluorescent materials for use in the organic EL devices of this invention. Dopants which can be used include diphenylacridine, coumarins, perylene and their derivatives.

Useful fluorescent dopants are disclosed in U.S. Pat. No. 4,769,292.

The preferred dopants are coumarins such as those of formula 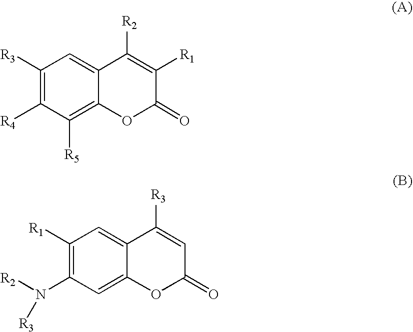
where R₁ is chosen from the group consisting of hydrogen, carboxy, alkanoyl, alkoxycarbonyl, cyano, aryl, and a heterocylic aromatic group, R₂ is chosen from the group consisting of hydrogen, alkyl, haloalkyl, carboxy, alkanoyl, and alkoxycarbonyl, R₃ is chosen from the group consisting of hydrogen and alkyl, R₄ is an amino group, and R₅ is hydrogen, or R₁ or R₂ together form a fused carbocyclic ring, and/or the amino group forming R⁴ completes with at least one of R⁴ and R⁶ a fused ring.

The alkyl moieties in each instance contain from 1 to 5 carbon atoms, preferably 1 to 3 carbon atoms. The aryl moieties are preferably phenyl groups. The fused carbocyclic rings are preferably five, six or seven membered rings. The heterocyclic aromatic groups contain 5 or 6 membered heterocyclic rings containing carbon atoms and one or two heteroatoms chosen from the group consisting of oxygen, sulfur, and nitrogen. The amino group can be a primary, secondary, or tertiary amino group. When the amino nitrogen completes a fused ring with an adjacent substituent, the ring is preferably a five or six membered ring. For example, R⁴ can take the form of a pyran ring when the nitrogen atom forms a single ring with one adjacent substituent (R³ or R⁵) or a julolidine ring (including the fused benzo ring of the coumarin) when the nitrogen atom forms rings with both adjacent substituents R₃ and R₅.

The following are illustrative fluorescent coumarin dyes known to be useful as laser dyes: FD-1 7-Diethylamino-4-methylcoumarin, FD-2 4,6-Dimethyl-7-ethylaminocoumarin, FD-3 4-Methylumbelliferone, FD-4 3-(2′-Benzothiazolyl)-7-diethylaminocoumarin, FD-5 3-(2′-Benzimidazolyl)-7-N,N-diethylaminocoumarin, FD-6 7-Amino-3-phenylcoumarin, FD-7 3-(2′-N-Methylbenzimidazolyl)-7-N,Ndiethylaminocoumarin, FD-8 7-Diethylamino-4-trifluoromethylcoumarin, FD-9 2,3,5,6-1H,4H-Tetrahydro-8-methylquinolazino[9,9a,1-gh]coumarin, FD-10 Cyclopenta[c]julolindino[9,10-3]-11H-pyran-11-one, FD-11 7-Amino-4-methylcoumarin, FD-12 7-Dimethylaminocyclopenta[c]coumarin, FD-13 7-Amino-4-trifluoromethylcoumarin, FD-14 7-Dimethylamino-4-trifluoromethylcoumarin, FD-15 1,2,4,5,3H,6H,10H-Tetrahydro-8-trifluoromethyl[1]benzopyrano[9,9a,1-gh]quinolizin-10-one, FD-16 4-Methyl-7-(sulfomethylamino)coumarin sodium salt, FD-17 7-Ethylamino-6-methyl-4-trifluoromethylcoumarin, FD-18 7-Dimethylamino-4-methylcoumarin, FD-19 1,2,4,5,3H,6H,10H-Tetrahydro-carbethoxy[1]benzopyrano[9,9a,1-gh]quinolizino-10-one, FD-20 9-Acetyl-1,2,4,5,3H,6H,10H-tetrahydro[1]benzopyrano[9,9a,1-gh]quinolizino-10-one, FD-21 9-Cyano-1,2,4,5,3H,6H,10H-tetrahydro[1]benzopyrano[9,9a,1-gh]quinolizino-10-one, FD22 9-(t-Butoxycarbonyl)-1,2,4,5,3H,6H,10H-tetrahyro[1]benzopyrano[9,9a,1-gh]quinolizino-10-one, FD-23 4-Methylpiperidino[3,2-g]coumarin, FD-24 4-Trifluoromethylpiperidino[3,2-g]coumarin, FD-25 9-Carboxy-1,2,4,5,3H,6H,10H-tetrahydro[1]benzopyrano[9,9a,1-gh]quinolizino-10-one, FD-26 N-Ethyl-4-trifluoromethylpiperidino[3,2-g].

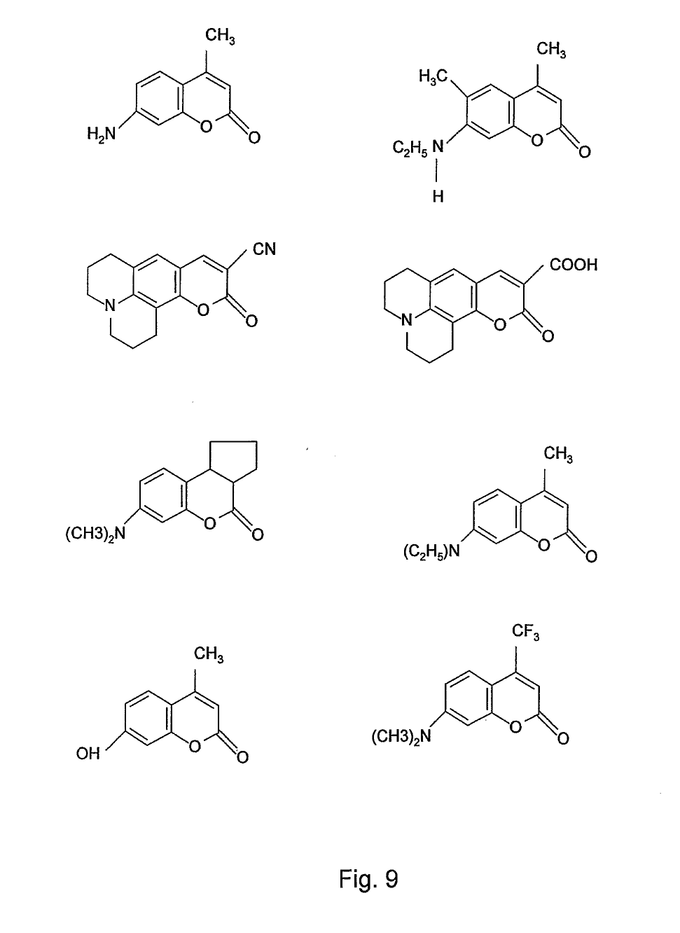

Other examples of coumarins are given in FIG. 9 of the drawings.

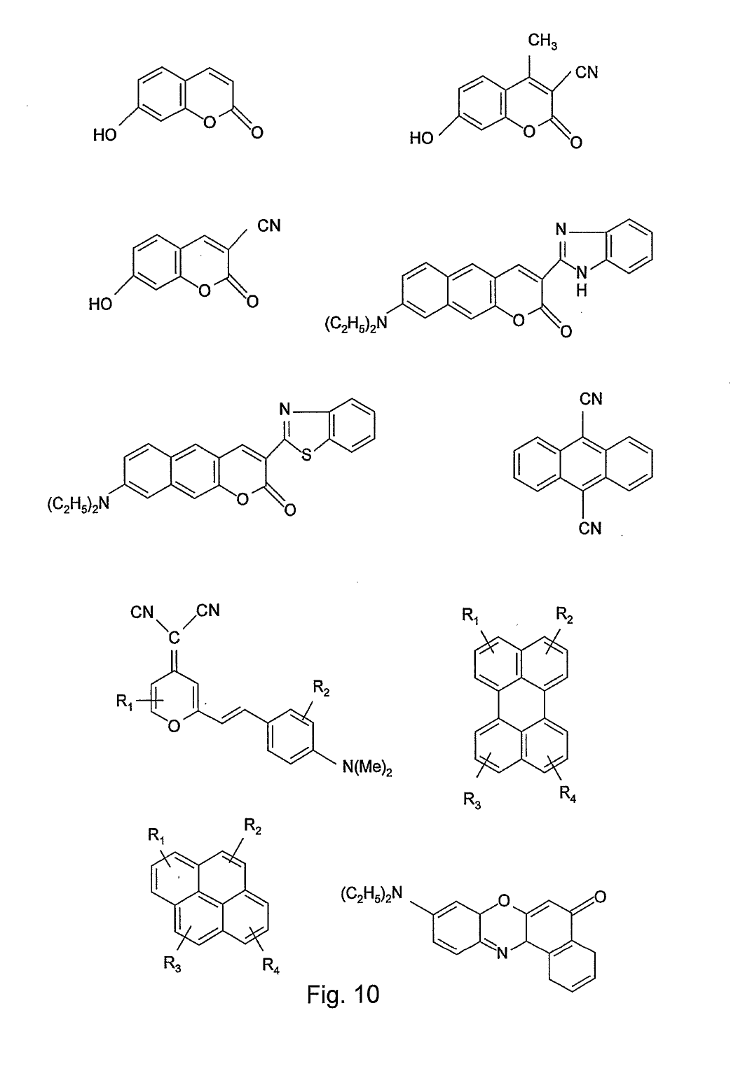

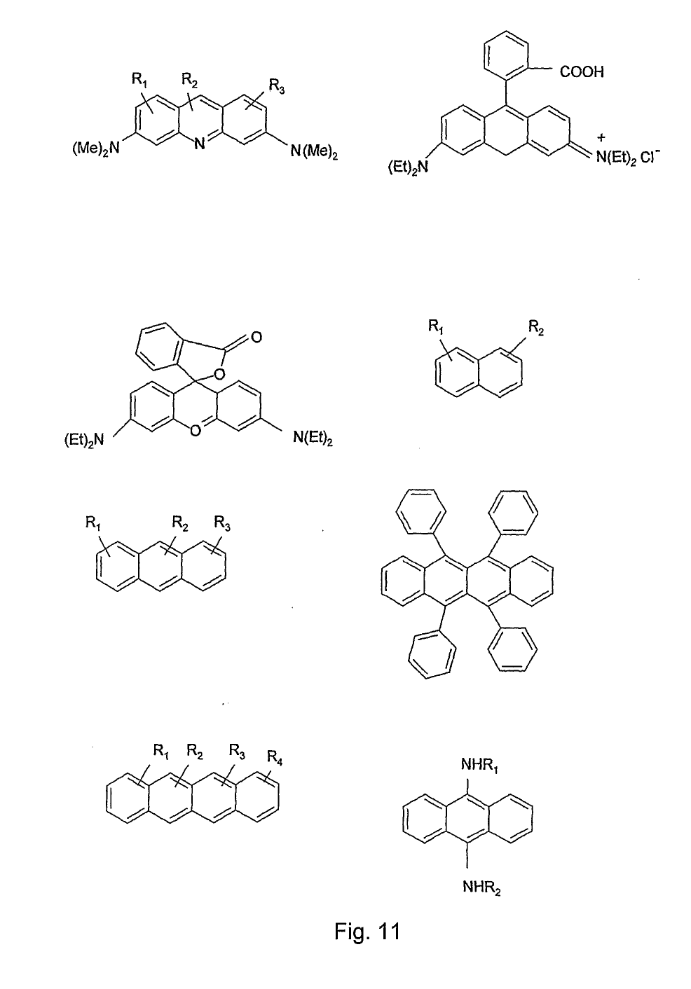

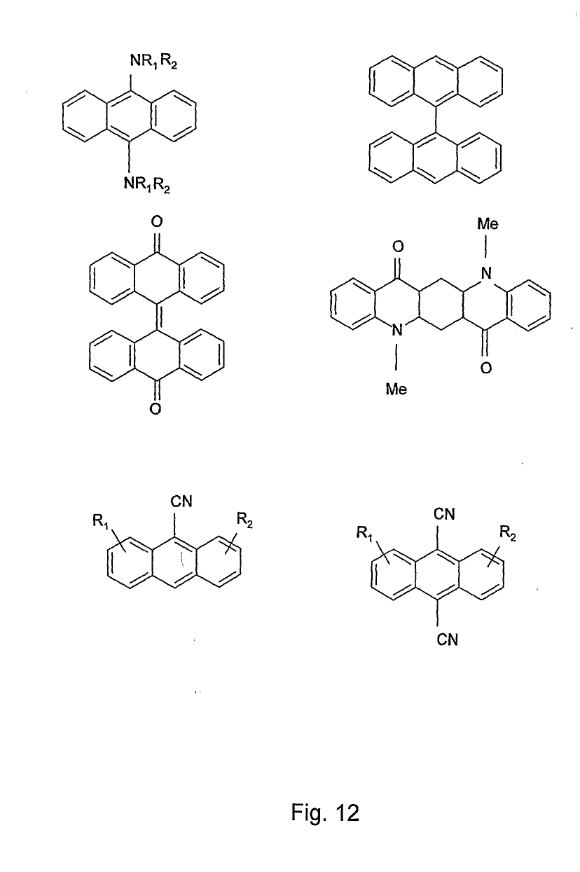

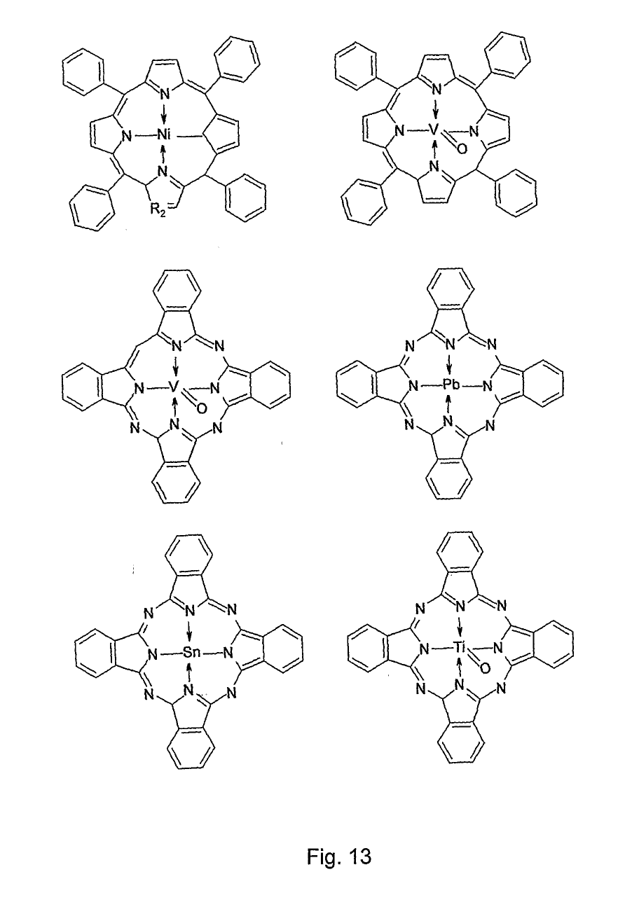

Other dopants include salts of bis benzene sulphonic acid such as 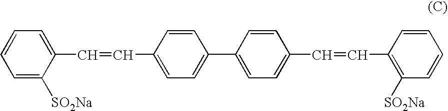
and perylene and perylene derivatives and dopants of the formulae of FIGS. 10 to 13 of the drawings where R₁, R₂, R₃ and R₄ are R, R₁, R₂, R₃ and R₄ can be the same or different and are selected from hydrogen, hydrocarbyl groups, substituted and unsubstituted aromatic, heterocyclic and polycyclic ring structures, fluorocarbons such as trifluoryl methyl groups, halogens such as fluorine or thiophenyl groups; R, R₁, R₂, R₃ and R₄ can also form substituted and unsubstituted fused aromatic, heterocyclic and polycyclic ring structures and can be copolymerisable with a monomer e.g. styrene. R, R₁, R₂, R₃ and R₄ can also be unsaturated alkylene groups such as vinyl groups or groups
—C—CH₂═CH₂—R
where R is as above.

Other dopants are dyes such as the fluorescent 4-dicyanomethylene-4H-pyrans and 4-dicyanomethylene-4H-thiopyrans, e.g. the fluorescent dicyanomethylenepyran and thiopyran dyes.

Useful fluorescent dyes can also be selected from among known polymethine dyes, which include the cyanines, merocyanines, complex cyanines and merocyanines (i.e. tri-, tetra- and poly-nuclear cyanines and merocyanines), oxonols, hemioxonols, styryls, merostyryls, and streptocyanines.

The cyanine dyes include, joined by a methine linkage, two basic heterocyclic nuclei, such as azolium or azinium nuclei, for example, those derived from pyridinium, quinolinium, isoquinolinium, oxazolium, thiazolium, selenazolium, indazolium, pyrazolium, pyrrolium, indolium, 3H-indolium, imidazolium, oxadiazolium, thiadioxazolium, benzoxazolium, benzothiazolium, benzoselenazolium, benzotellurazolium, benzimidazolium, 3H- or 1H-benzoindolium, naphthoxazolium, naphthothiazolium, naphthoselenazolium, naphthotellurazolium, carbazolium, pyrrolopyridinium, phenanthrothiazolium, and acenaphthothiazolium quaternary salts.

Other useful classes of fluorescent dyes are 4-oxo-4H-benz-[d,e]anthracenes and pyrylium, thiapyrylium, selenapyrylium, and telluropyrylium dyes.

The first electrode can function as the anode and the second electrode can function as the cathode and preferably there is a layer of a hole transporting material between the anode and the layer of the electroluminescent compound.

The hole material can be any of the hole transporting materials used in electroluminescent devices.

The hole transporting material can be an amine complex such as poly (vinylcarbazole), N,N′-diphenyl-N,N′-bis (3-methylphenyl)-1,1′-biphenyl-4,4′-diamine (TPD), an unsubstituted or substituted polymer of an amino substituted aromatic compound, a polyaniline, substituted polyanilines, polythiophenes, substituted polythiophenes, polysilanes etc. Examples of polyanilines are polymers of 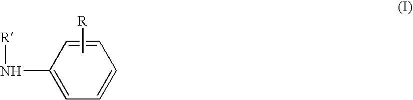
where R is in the ortho—or meta-position and is hydrogen, C1-18 alkyl, C1-6 alkoxy, amino, chloro, bromo, hydroxy or the group 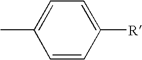
where R is alky or aryl and R′ is hydrogen, C1-6 alkyl or aryl with at least one other monomer of formula (I) above.

Or the hole transporting material can be a polyaniline; polyanilines which can be used in the present invention have the general formula 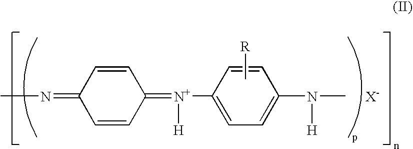
where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkysulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate; an example of an arenedicarboxylate is phthalate and an example of arenecarboxylate is benzoate.

We have found that protonated polymers of the unsubstituted or a substituted polymer of an amino substituted aromatic compound such as a polyaniline are difficult to evaporate or cannot be evaporated; however we have surprisingly found that if the unsubstituted or substituted polymer of an amino substituted aromatic compound is deprotonated, then it can be easily evaporated, i.e. the polymer is evaporable.

Preferably evaporable deprotonated polymers of unsubstituted or a substituted polymer of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F. Epstein, Faraday Discussions, Chem Soc. 88 P 319 1989.

The conductivity of the polyaniline is dependent on the degree of protonation with the maximum conductivity being when the degree of protonation is between 40 and 60%, for example, about 50%.

Preferably the polymer is substantially fully deprotonated.

A polyaniline can be formed of octamer units. i.e. p is four, e.g.

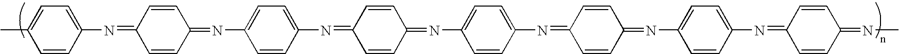

The polyanilines can have conductivities of the order of 1×10⁻¹ Siemen cm⁻¹ or higher.

The aromatic rings can be unsubstituted or substituted, e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an amino substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted, e.g. by a group R as defined above.

Other hole transporting materials are conjugated polymer and the conjugated polymers which can be used can be any of the conjugated polymers disclosed or referred to in U.S. Pat. No. 5,807,627, PCT/WO90/13148 and PCT/WO92/03490.

The preferred conjugated polymers are poly (p-phenylenevinylene)-PPV and copolymers including PPV. Other preferred polymers are poly(2,5 dialkoxyphenylene vinylene) such as poly (2-methoxy-5-(2-methoxypentyloxy-1,4-phenylene vinylene), poly(2-methoxypentyloxy)-1,4-phenylenevinylene), poly(2-methoxy-5-(2-dodecyloxy-1,4-phenylenevinylene) and other poly(2,5 dialkoxyphenylenevinylenes) with at least one of the alkoxy groups being a long chain solubilising alkoxy group, poly fluorenes and oligofluorenes, polyphenylenes and oligophenylenes, polyanthracenes and oligo anthracenes, ploythiophenes and oligothiophenes.

In PPV the phenylene ring may optionally carry one or more substituents, e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as anthracene or naphthlyene ring and the number of vinylene groups in each polyphenylenevinylene moiety can be increased, e.g. up to 7 or higher.

The conjugated polymers can be made by the methods disclosed in U.S. Pat. No. 5,807,627, PCT/WO90/13148 and PCT/WO92/03490.

The thickness of the hole transporting layer is preferably 20 nm to 200 nm.

The polymers of an amino substituted aromatic compound such as polyanilines referred to above can also be used as buffer layers with or in conjunction with other hole transporting materials.

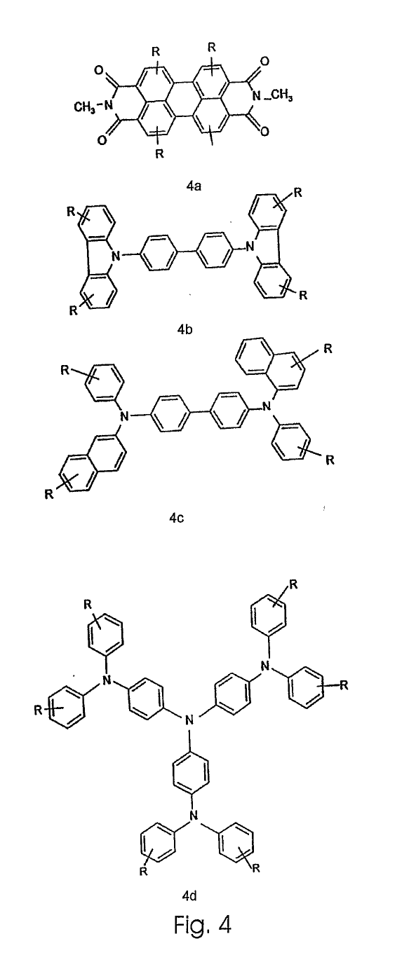

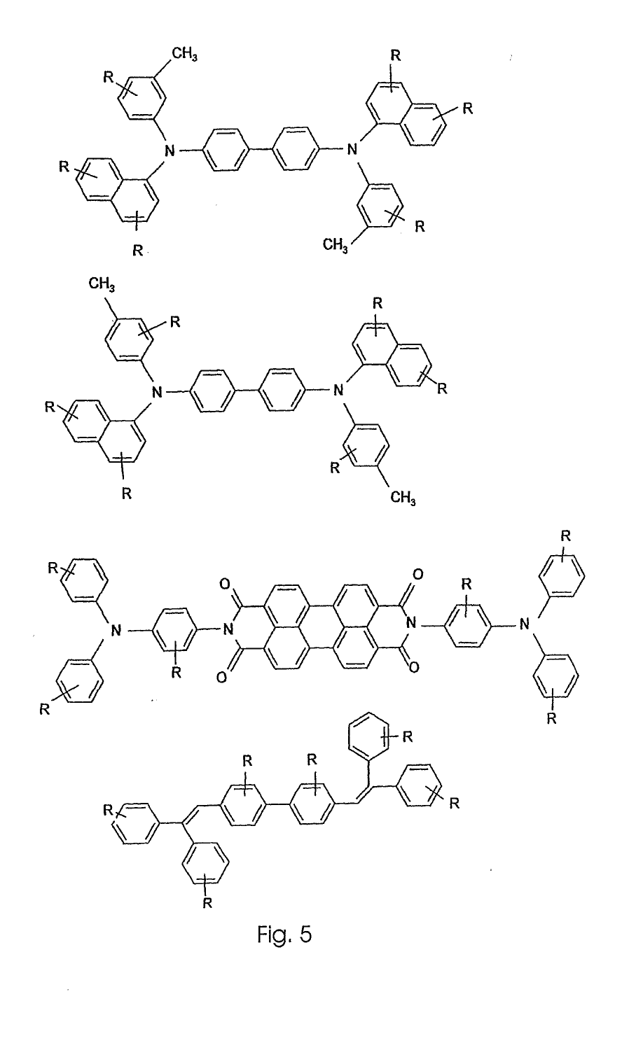

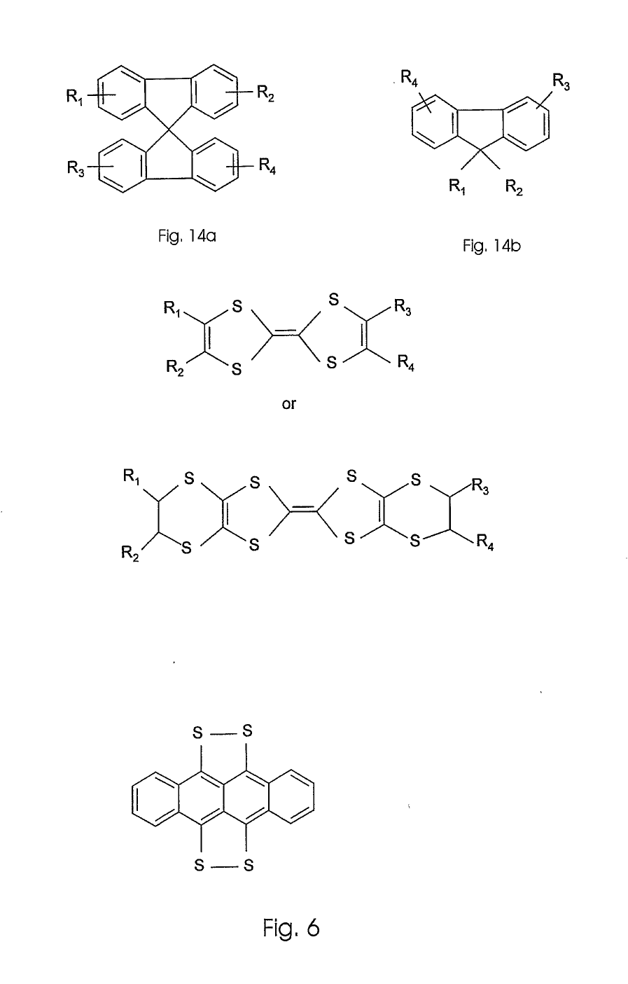

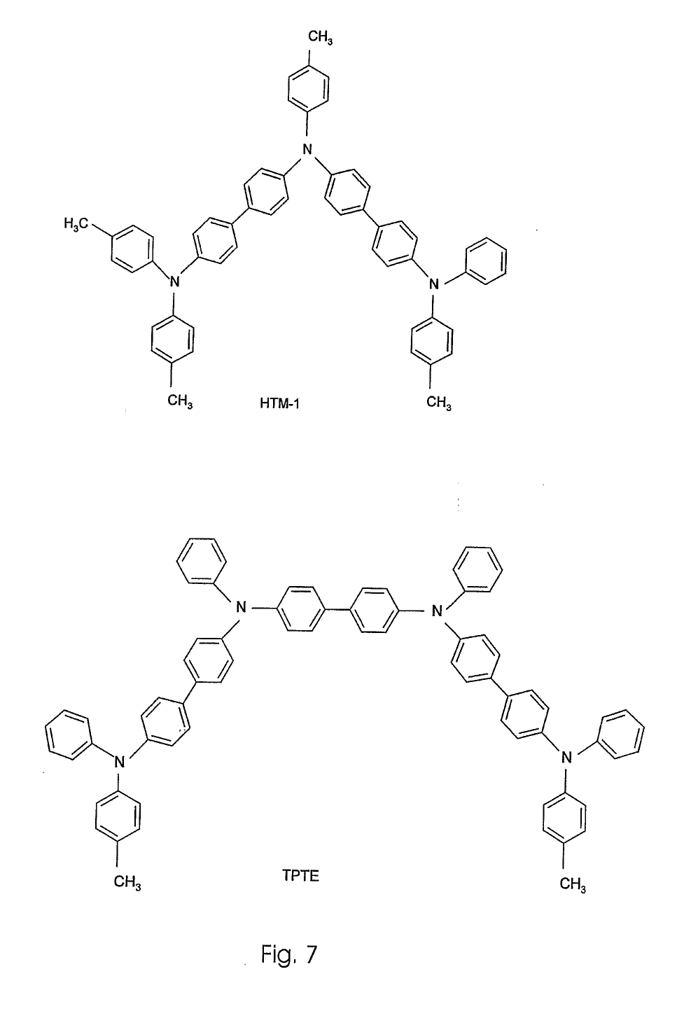

The structural formulae of some other hole transporting materials are shown in FIGS. 4, 5, 6, 7 and 8 of the drawings, where R₁, R₂ and R₃ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene. X is Se, S or O, Y can be hydrogen, substituted or unsubstituted hydrocarbyl groups, such as substituted and unsubstituted aromatic, heterocyclic and polycyclic ring structures, fluorine, fluorocarbons such as trifluoryl methyl groups, halogens such as fluorine or thiophenyl groups or nitrile.

Examples of R₁ and/or R₂ and/or R₃ include aliphatic, aromatic and heterocyclic alkoxy, aryloxy and carboxy groups, substituted and substituted phenyl, fluorophenyl, biphenyl, phenanthrene, anthracene, naphthyl and fluorene groups alkyl groups such as t-butyl, heterocyclic groups such as carbazole.

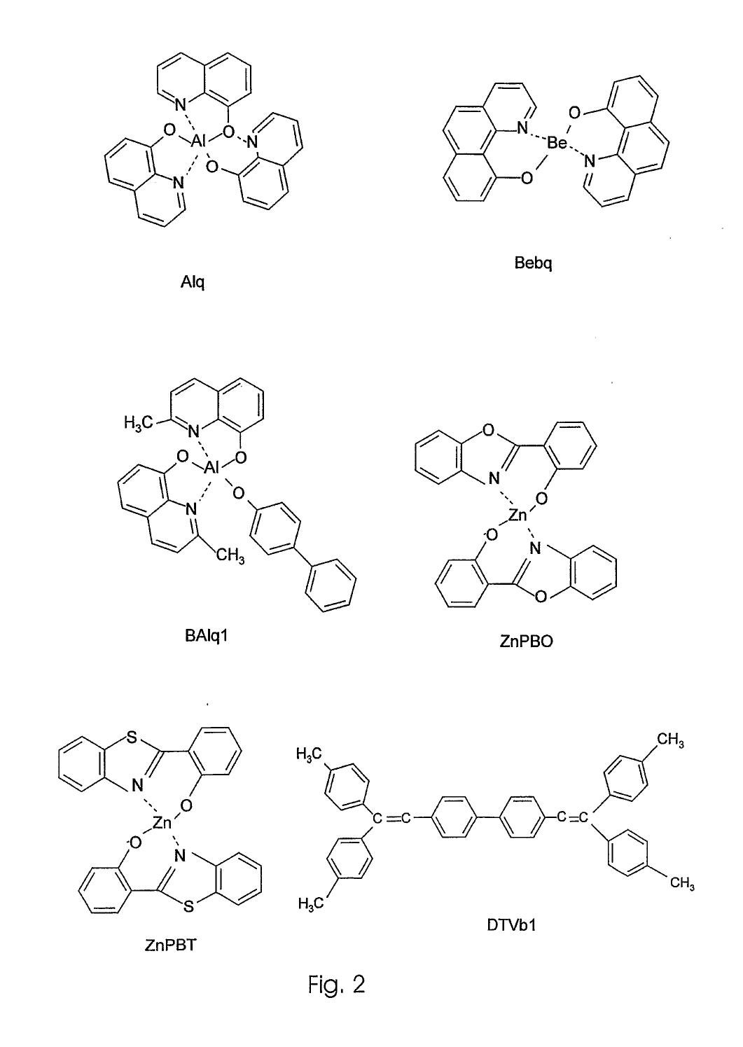

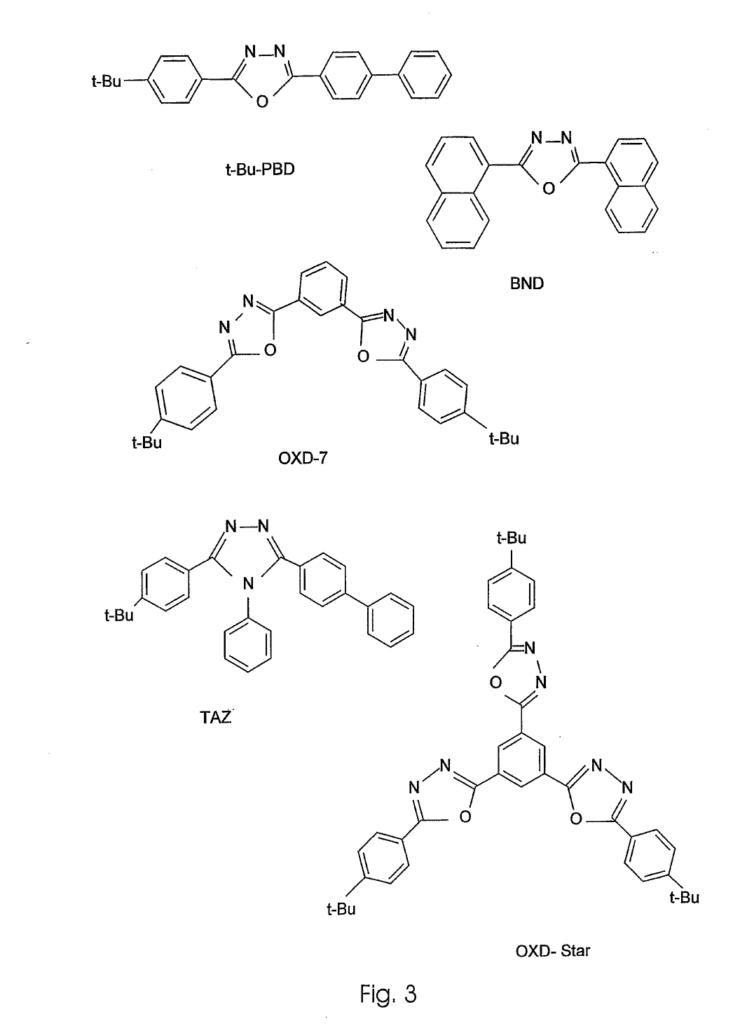

Optionally there is a layer of an electron injecting material between the anode and the electroluminescent material layer. The electron injecting material is a material which will transport electrons when an electric current is passed through it; electron injecting materials include a metal complex such as a metal quinolate, e.g. an aluminium quinolate, lithium quinolate, zirconium quinolate, hafnium quinolate, a cyano anthracene such as 9,10 dicyano anthracene, cyano substituted aromatic compounds, tetracyanoquinidodimethane a polystyrene sulphonate or a compound with the structural formulae shown in FIGS. 2 or 3 of the drawings in which the phenyl rings can be substituted with substituents R as defined above. The thickness of the electron injecting layer and other layers are such that the electrons from the cathode and the holes from the anode meet in the electroluminescent layer.

When the electroluminescent layer in an electroluminescent device comprises a doped zirconium 2-methyl quinolate, then a preferred electron injecting material is a quinolate such as a zirconium, hafnium, vanadium, titanium, vanadium, niobium or tantulum quinolate.

The first electrode is preferably a transparent substrate such as a conductive glass or plastic material which acts as the anode; preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate.

The cathode is preferably a low work function metal, e.g. aluminium, calcium, lithium, silver/magnesium alloys, rare earth metal alloys etc; aluminium is a preferred metal. A metal fluoride such as an alkali metal, rare earth metal or their alloys can be used as the second electrode, for example by having a metal fluoride layer formed on a metal.

The improved performance of 2-methyl zirconium quinolates compared with aluminium quinolate is particularly shown in the efficiency of the electroluminescent compound although there is an improvement in a range of properties, e.g. lifetime, stability etc.

The invention is illustrated in the Examples.

### EXAMPLE 1

### Synthesis of Tetrakis(8-hydroxyquinaldinato) Zirconium (IV)

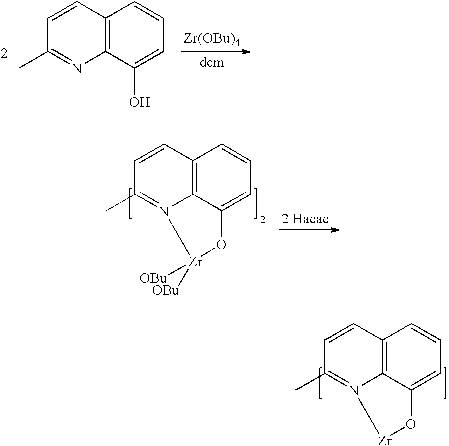

A 2-necked 250 mL round-bottomed flask fitted with a nitrogen-inlet, was charged with 8-hydroxyquinaldine (10.0 g, 62.8 mmol) and dichloromethane (150 mL). Zirconium(IV) butoxide (80% wt in 1-butanol, 14.2 mL, 31 mmol) was rapidly added (in one portion) to this stirred solution. After stirring for 2 minutes at room temperature, 2,4-pentanedione(Hacac) (6.47 mL, 63 mmol) was quickly added via a syringe. Stirring was continued for a further 10 minutes at room temperature under a constant stream of nitrogen gas. The small amount of precipitate thus formed was removed by gravity filtration and the filtrate reduced in volume to approx. 60 mL. Petroleum spirit (40-60° boiling range, 120 mL) was carefully layered above the dichloromethane. Storage of this mixture at 5° C. for 6 hours yielded a yellow precipitate. This was isolated, washed with further petroleum spirit (3×100 mL) and ethanol (50 mL) and dried in vacuo at 80° C. for 12 hours. Further purification was achieved by entrainment sublimation. Yield 3.2 g (29%, doubly sublimed) M.p. 395° C.

Elemental Analysis: Calc. C, 66.36, H, 4.46, N, 7.74; Found. C, 66.17, H, 4.33, N, 7.76.

### EXAMPLE 2

### Electroluminescent Device

A pre-etched ITO coated glass piece (10×10 cm²) was used. The device was fabricated by sequentially forming on the ITO, by vacuum evaporation using a Solciet Machine, ULVAC Ltd. Chigacki, Japan. The active area of each pixel was 3 mm by 3 mm, the layers comprised:-

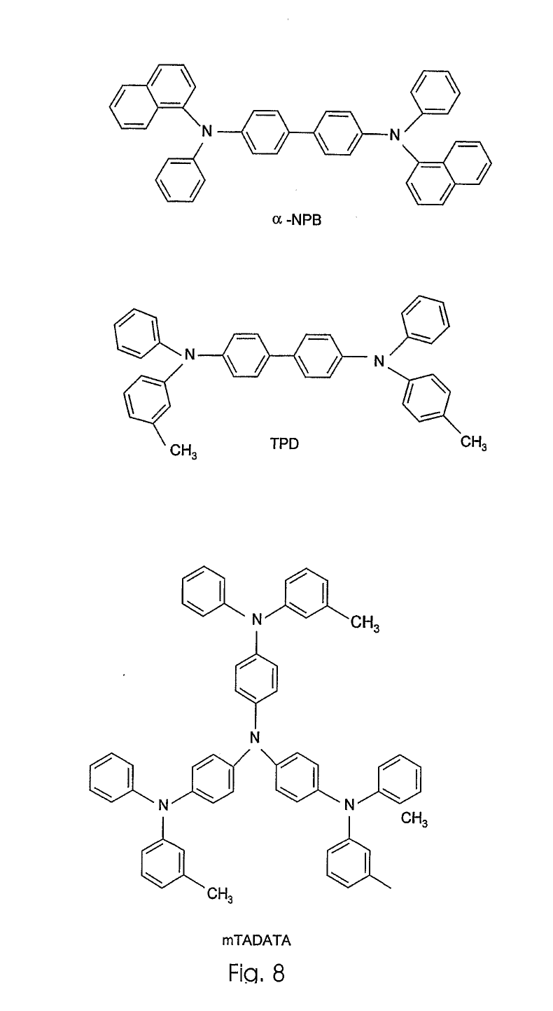

(1) ITO/(2) D(20 nm)/(3) α-NPB (50 nm)/(4) Zrq₄-2Me:DPQA (40 : 0.1 nm)/(4) Hfq₄ (20 nm)/(5) LiF (0.3 nm)/(6) Al

Where ITO is indium tin oxide coated glass D is as shown below, α-NPB is as shown in FIG. 8, Zrq₄-2Me is tetrakis(8-hydroxyquinaldinato) zirconium (IV) as made in Example 1, DPQA is diphenylquinacridine and Hfq₄ is hafnium quinolate.

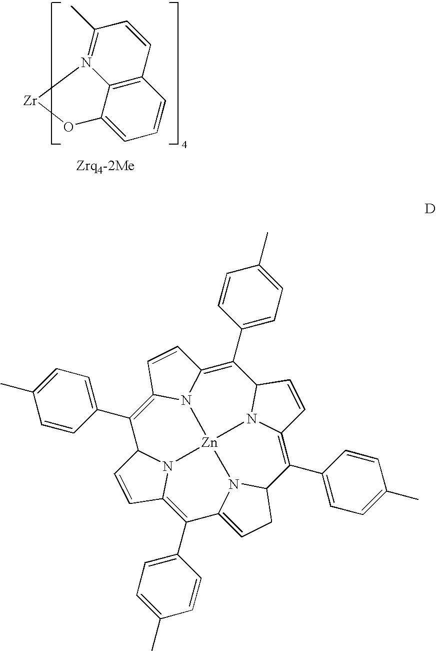

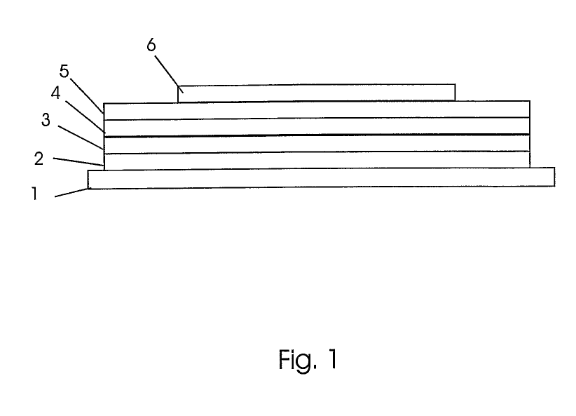

The device had the structure of FIG. 1.

The Zrq₄-2Me:DPQA layer was formed by concurrent vacuum deposition to form a 2-Me zirconium quinolate layer doped with DPQA. The weight ratio of the Zrq₄-2Me and DPQA is conveniently shown by a relative thickness measurement.

The coated electrodes were stored in a vacuum desiccator over a molecular sieve and phosphorous pentoxide until they were loaded into a vacuum coater (Edwards, 10⁻⁶ torr) and aluminium top contacts made. The devices were then kept in a vacuum desiccator until the electroluminescence studies were performed.

The ITO electrode was always connected to the positive terminal. The current vs. voltage studies were carried out on a computer controlled Keithly 2400 source meter.

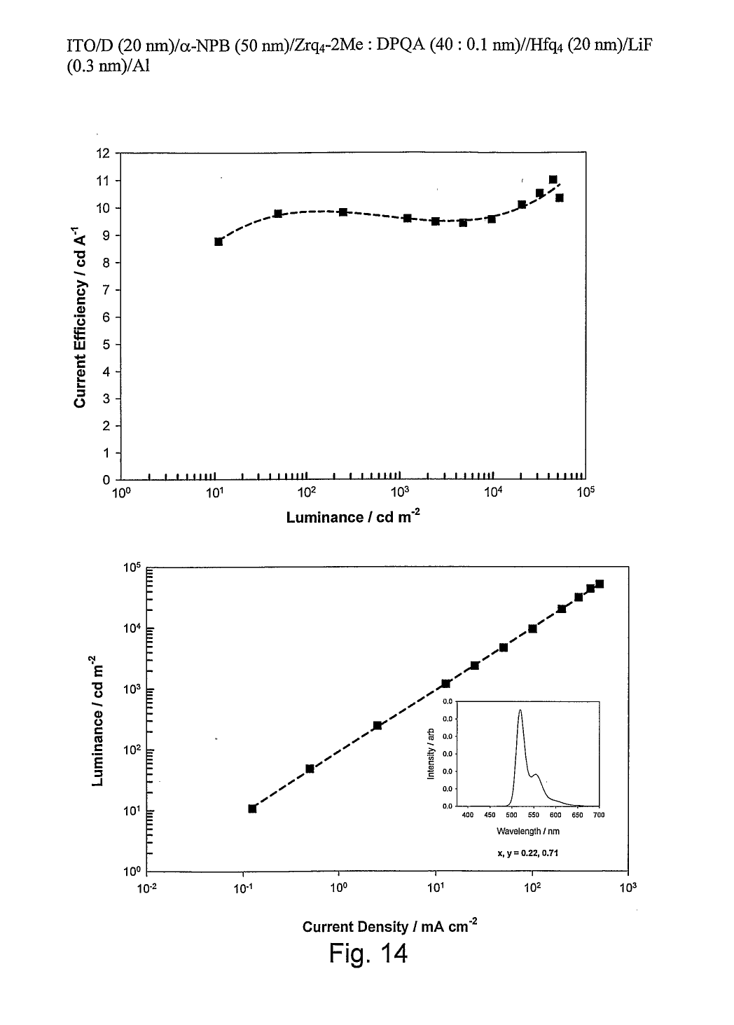

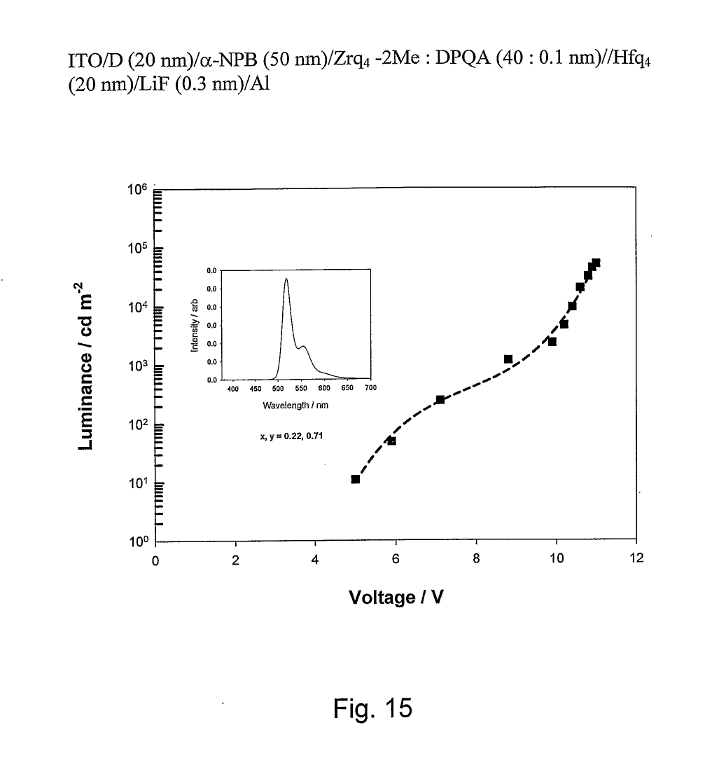

An electric current was applied across the device and the performance shown in FIGS. 14 and 15.

1.-32. (canceled)

33. A method for the manufacture of a substituted or unsubstituted zirconium 2-methyl quinolate comprising the sequential steps of:
(a) reacting a zirconium salt having the general chemical formula ZrL₄, where L is an anion, with a substituted or unsubstituted 2-methyl 8-hydroxy quinoline to form a mixed salt Zr(q-2Me)₂L₂; and,
(b) reacting the mixed salt with a beta diketone to form a corresponding zirconium 2-methyl quinolate.

34. The method of claim 33, wherein the anion L is an alkoxide.

35. The method of claim 33, wherein the beta diketone is 2,4 pentanedione.

36. The method of claim 33, wherein the reactions are carried out in an organic solvent.

37. The method of claim 33, wherein the 2-methyl 8-hydroxy quinoline has the general chemical formula 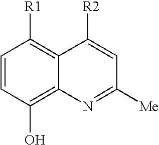
where R₁ and R₂, which may be the same or different, are independently selected from the group consisting of hydrogen, alkyl, alkoxy, aryl, aryloxy, sulphonic acids, esters, carboxylic acids, amino and amido groups, aromatic groups, polycyclic groups and heterocyclic groups.

38. The method of claim 33, said method further comprising the step of doping the substituted or unsubstituted zirconium 2-methyl quinolate with a fluorescent dopant.

39. The method of claim 38, wherein the dopant is selected such that it has a bandgap no greater than that of the zirconium 2-methyl quinolate and also has a reduction potential less negative than that of the zirconium 2-methyl quinolate.

40. The method of claim 38, wherein the fluorescent dopant is selected from the group consisting of diphenylacridine, coumarins, perylenes, quinolates, porphoryins, porphines, pyrazalones and their derivatives, polymethine dyes, complex cyanines and merocyanines, oxonols, hemioxonols, styryls, merostyryls, and streptocyanines.

40. The method of claim 38, wherein the fluorescent dopant is a coumarin compound selected from the group consisting of: 7-Diethylamino4-methylcoumarin; 4,6-Dimethyl-7-ethylaminocoumarin; 4-Methylumbelliferone; 3-(2′-Benzothiazolyl)-7-diethylaminocoumarin; 3-(2′-Benzimidazolyl)-7-N,N-diethylaminocoumarin; 7-Amino-3-phenylcoumarin; 3-(2′-N-Methylbenzimidazolyl)-7-N,Ndiethylaminocoumarin; 7-Diethyl-amino-4-trifluoromethylcoumarin; 2,3,5,6-1H,4H-Tetrahydro-8-methylquinolazino [9,9a,1-gh]coumarin; Cyclopenta[c]julolindino[9,10-3]-11H-pyran-11-one; 7-Amino-4-methyl-coumarin; 7-Dimethylaminocyclopenta[c]coumarin; 7-Amino-4-trifluoromethyl-coumarin; 7-Dimethylamino-4-trifluoromethylcoumarin; 1,2,4,5,3H,6H,10H-Tetrahydro-8-trifluoromethyl [1]benzopyrano[9,9a,1-gh]quinolizin-10-one; 4-Methyl-7-(sulfomethylamino)coumarin sodium salt; 7-Ethylamino-6-methyl-4-trifluoromethylcoumarin; 7-Dimethylamino-4-methylcoumarin; 1,2,4,5,3H,6H, 10H-Tetrahydro-carbethoxy[1]benzopyrano [9,9a, 1-gh] quinolizino-10-one; 9-Acetyl-1,2,4,5,3H,6H,10H-tetrahydro[1]benzopyrano [9,9a,1-gh] quinolizino-10-one; 9-Cyano-1,2,4,5,3H,6H,10H-tetrahydro[1]benzopyrano[9,9a,1-gh] quinolizino-10-one; 9-(t-Butoxy carbonyl)-1,2,4,5,3H,6H,10H-tetrahyro[1]benzopyrano [9,9a,1-gh]quinolizino-10-one, 4-Methylpiperidino[3,2-g]coumarin; 4-Trifluoro-methylpiperidino[3,2-g]coumarin; 9-Carboxy-1,2,4,5,3H,6H,10H-tetrahydro[1]benzopyrano [9,9a,1-gh]quinolizino-10-one; and N-Ethyl4-trifluoromethylpiperidino[3,2-g]; or alternatively is a compound selected from the group consisting of: 7-amino-4-methyl-2H-chromen-2-one; 7-(ethylamino)-4,6-dimethyl-2H-chromen-2-one; 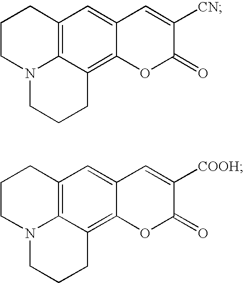
7-(dimethylamino)-2,3-dihydrocyclopenta[c]chromen-4(1H)-one; 7-(diethylamino)-4-methyl-2H-chromen-2-one; 7-hydroxy-4-methyl-2H-chromen-2-one and 7-(diethylamino)-4-(trifluoromethyl)-2H-chromen-2-one.

42. The method of claim 38, wherein the fluorescent dopant is added in an amount ranging from about 10⁻³ mole percent to 10 mole percent based on the total moles of zirconium 2-methyl quinolate.

43. The method of claim 33, said method further comprising the steps of incorporating the substituted or unsubstituted zirconium 2-methyl quinolate into an electroluminescent device to form a device comprising: (i) a first electrode; (ii) a second electrode; and (iii) a layer of an electroluminescent material located between the first and the second electrodes, said electroluminescent material comprising said substituted or unsubstituted 2-methyl zirconium quinolate.

44. A method for the manufacture of tetrakis(8-hydroxyquinaldinato) zirconium (IV) comprising the steps of: (a) reacting a zirconium salt having the general chemical formula ZrL₄, wherein L is an anion, with 2-methyl-8-hydroxyquinoline to form the mixed salt having the general chemical formula Zr(q-2Me)₂L₂, wherein the entity “q-2Me” represents a 2-methylquinolate group; and (b) thereafter reacting the mixed salt with a beta-diketone to form tetrakis(8-hydroxyquinaldinato) zirconium (IV).
